(19) United States
(12) Patent Application Publication
(10) Pub. No.: US 2011/0147020 A1
(43) Pub. Date: Jun. 23, 2011

(54) T-point lift, three-point hitch/lift system for 2" receivers

(76) Inventors: Kelly Scot Waltz, Ivanhoe, TX (US); Carey Brent Nelson, Ivanhoe, TX (US)

(21) Appl. No.: 12/928,620

(22) Filed: Dec. 15, 2010

Related U.S. Application Data
(60) Provisional application No. 61/284,476, filed on Dec. 18, 2009.

(51) Int. Cl. A01B 59/043

(52) U.S. Cl. 172/439

(57) ABSTRACT

The T-Point Lift is an electrically actuated, hydraulic, removable three-point hitch/lift assembly, which is installed on vehicles and equipment having a 2″ receiver mount, for quick installation and removal by one person. An inverted T shaped mounting frame with mounting points for an upper lift arm and two lower lift arms is inserted into a vehicles receiver. A hydraulic cylinder is mounted to the lift frame and upper lift arm which carries any attached load with assistance from attached lift links transferring the load to lower lift arms and providing sway control. An electrical power source is the only requirement for the attached hydraulic power pack with controls, thus not requiring any modification to the vehicle or equipment, to employ the apparatus in the manor for which it was designed, which tractor implements can be installed and used in accordance with their intended use up to and including category 1 three point implements.

### CROSS-REFERENCE RELATED TO APPLICATION

This application claims the benefit of U.S. Provisional Patent Application Ser. No. 61/284,476, filed on Dec. 18, 2009.

### BACKGROUND OF THE INVENTION

This invention is intended as a three-point hitch/lift system for vehicles or equipment having a 2-inch receiver hitches mounted to their frame. The T-Point Lift system was designed from the ground up to be compatible for installation with all standard 2-inch frame mounted receiver hitches and only requiring a vehicle power source or battery. The vehicles recommended for use include, but are not limited to pickup trucks, SUVs, Jeeps, utility vehicles and ATV's. All having in common the 2″ standardized frame mounted towing receiver.

Unlike the apparatus disclosed in U.S. Pat. No. 6,148,928 to Spears, Nov. 21, 2000, (referred to herein as Spears) it does not limit it to only being used on a pickup truck. Whereas the Spears device has an additional mount requirement of a gooseneck hitch, The T-Point Lift can be used by any vehicle or piece of equipment having only a two inch receiver mount either front or rear. The T-Point Lift also does not have any other permanent mounting requirements of associated frame work or brackets for attaching the three point hitch to the vehicle or equipment as outlined in the apparatuses disclosed in U.S. Pat. No. 5,423,394 to Kendle on Jun. 13, 1995 (referred to herein as Kendle), U.S. Pat. No. 4,940,096 to Johnson on Jul. 10, 1990 and U.S. Pat. No. 5,346,018 to Koster on Sep. 13, 1994, thereby permitting it to be installed and removed completely and efficiently, by one person, to one or more vehicles as if it were a receiver towing hitch.

The three-point design can utilize most category 1 implements not requiring a PTO making it simpler to operate and install than the Kendle and Spears apparatuses. This invention is also suited for the use of lighter duty implements on ATV's and utility vehicles. Unlike the U.S. Pat. No. 5,746,275 to Cross on May 5, 1998, which required a mounting frame to the axle of an ATV, the mounting and use requirements of the T-Point lift three point hitch on an ATV or utility vehicle follows the same guidelines as the mounting requirements for larger vehicles in that they only need a receiver to insert the three point lift frame into for use and a vehicle power source or battery for the lift frame mounted hydraulic power pack. The structure of the frame assembly lends to rigid structural integrity and having the strength to lift larger implements or larger quantities of weight with the use of a hydraulically actuated cylinder and an electrically powered hydraulic power pack unlike the U.S. Pat. No. 6,257,347 to Campisi on Jul. 10, 2001 which uses a winch mounted at the top of a pivoting support. The rigid structure of the t-point lift frame will reduce the possibility of binding of an implement behind a tow vehicle or piece of equipment as in the design of all three point hitch lifting devices on tractors.

### SUMMARY OF THE INVENTION

The T-Point Lift equips a vehicle or piece of equipment with the versatile capability of a three-point hitch and benefits from the ease of installation and removal that a receiver hitch provides. In conjunction with no other permanent mounting requirements, it turns a vehicle into a tractor like device that is capable of breaking ground, plowing snow, leveling dirt and gravel, digging shallow trenches, and any other task that would require a small to mid-sized tractor to use the type of three point implements and with the power, safety and comfort of today's reliable and efficient vehicles and equipment. Some of the 3-point implements may include but is not limited to scraper boxes, scraper blades, landscape rakes, disks, plows, hayforks and pallet movers.

### BRIEF DESCRIPTION OF THE DRAWINGS

The following is a brief description of the drawings which form part of the specification.

FIG. 1 is a quartering view of the t-point lift three point hitch/lift assembly, to allow observation of parts referenced in the figure with the best possible definition of the indicated part. It is viewed as if the hitch were not mounted for use, but fully assembled and without a three point implement installed.

FIG. 2 is a view from where a three point implement were to be installed on the three point hitch/lift assembly and, to allow observation of parts referenced in the figure with the best possible definition of the indicated part.

FIG. 3 is the t-point lift three point hitch/lift invention from a silhouette view as if it were mounted to a vehicle with a three point implement mounted on the hitch for use in the raised position.

Similar reference numbers pertain to corresponding parts throughout all drawing figures.

### DETAILED DESCRIPTION OF THE INVENTION

The T-Point Lift system is comprised of components, when incorporated together and working properly, is designed to use three point implements and lift up to the rated weight capacity of the vehicle it is installed on, or up to 2000 lbs. The T-Point Lift system can be manufactured from steel, stainless steel, steel alloys, aluminum, aluminum alloys, titanium, carbon fiber, composites, and any combination of these materials or any other material suitable for stress loads that may be encountered as a component of the following hitch/lift assembly.

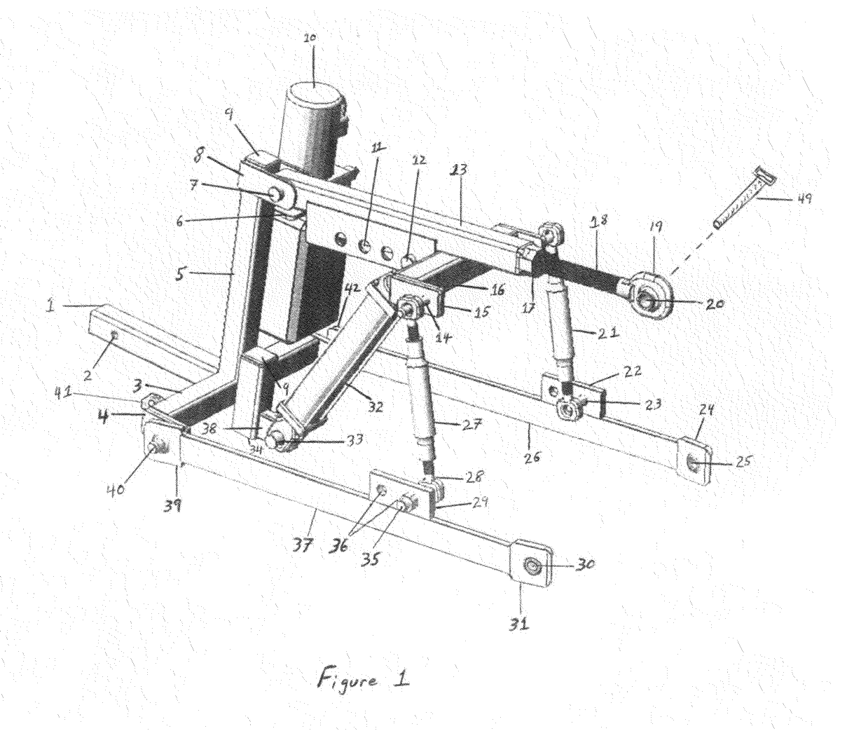

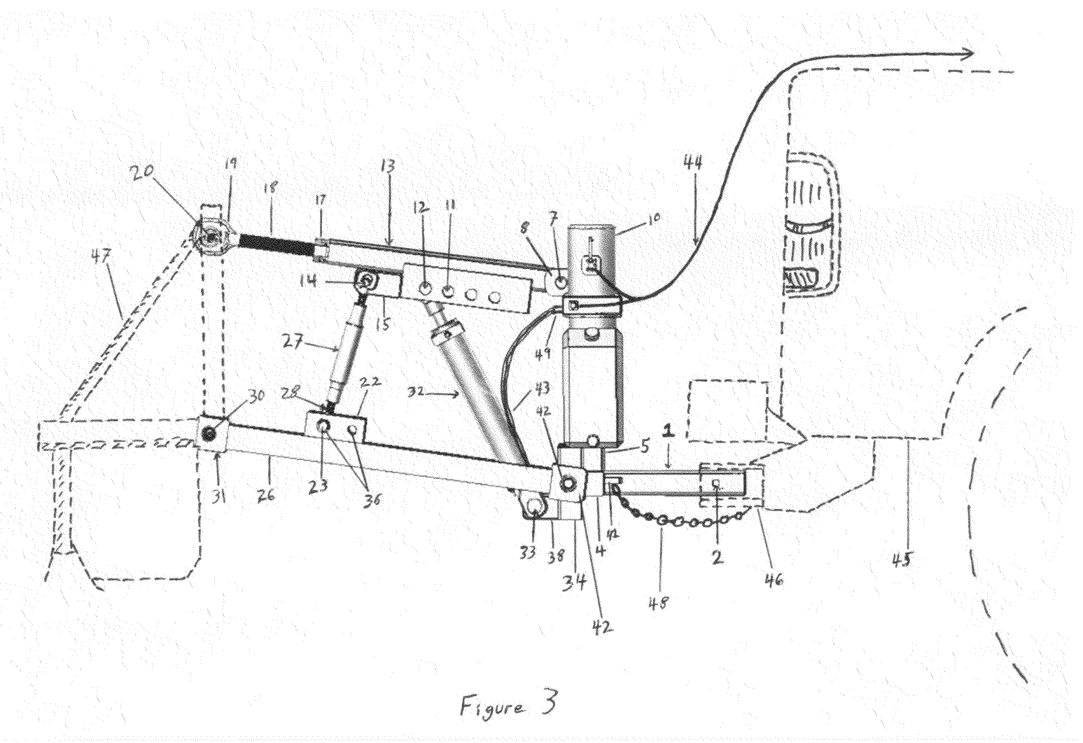

Initially referring to FIG. 3 and then referring to drawing FIGS. 1, 2 and 3, the lift frame consists of several components starting with a lift frame receiver mounting bar 1 that provides mounting to a vehicle 45, by inserting it into a 2 inch receiver hitch 46 and aligning the retaining pin holes 2, then installing a retaining pin through the pin holes in the hitch and lift frame receiver bar. The lift frame receiver bar is attached, opposite of the mounting end, to a square tube horizontal cross member 3, best viewed in FIG. 1. The horizontal cross member has tabs 41 attached near each end, which have a hole in the center for safety chains 48. The cross member also has a plate 4 attached, capping each end and extending rearward with a hole drilled in the tab that extends rearward, where replaceable lift points 40 are mounted. At the point where the receiver bar and horizontal cross member intersect, is attached a square vertical support tube 5. The lift frame vertical support tube has a mount 6 attached onto one side for mounting the hydraulic power pack assembly 10. At the top of the vertical support tube are two plates 8 attached onto each side of it. Each of these plates have a hole in the tab, that extends from the vertical support tube, which are to facilitate as a pivot point for mounting of the upper lift arm with a retaining pin 7. The vertical support tube has a cap 9 to keep debris or water from accumulating in the frame causing corrosion and eventual failure. At the point where the horizontal cross member 3 and the vertical support tube meet 5, opposite of the receiver mounting bar 1, attached and extending downward below the horizontal cross member, is a square frame strut 34, see FIG. 1. A cap 9, caps the frame strut. Attached on the rear, bottom edge, of the frame strut is a bottom hydraulic cylinder mount, 38, having a hole in it. This serves as a mount for the lower hydraulic cylinder pin 33.

Referring to drawing FIGS. 1, 2 and 3, the upper lift arm consists of a square tube 13 that extends outward from the pin 7 in the upper lift arm pivot point plates 8 at the top of the vertical support tube 5. Attached to each side of the lift arm square tube are two hydraulic cylinder-mounting plates 11. The square plates extend below the bottom edge of the lift arm tube, and have four adjustment holes aligned on each side to facilitate mounting of the hydraulic cylinder ram arm with pin 12. There are four different holes to accommodate different vehicle heights and to provide adjustment to attach different implements. On the bottom of the lift arm, square tube at the end of the hydraulic cylinder mounting plates a horizontal stabilizer bar 16 is attached to the lift arm square tube and the mounting plates. This horizontal stabilizer bar has at a plate 15 attached on each end, with a hole to accommodate a replaceable lift pin 14, to which a lift link is installed at each end extending downward to the lower lift arms. At the end of the lift arm square tube is a threaded joint 17 into which fits a threaded adjustable rod 18 that has a rod end 19 serves as the top mount point of three point hitch implements 47 via a pin hole 20. By inserting a top link pin 49 in pin hole 20 allows the upper lift arm to secure three point implements for use.

As seen in drawing FIGS. 1, 2 and 3, the lift links are an adjustable link that attached between the upper lift arm and lower lift arms and serve to stabilize the implements installed and to distribute the forces, caused by weight or oscillating implements, to the lift arms and lift frame. They are adjustable by means of a threaded barrel 21, 27 in the middle of opposite threaded rod ends 28. These rod ends have holes in the end to facilitate mounting to the upper and lower lift arms. In FIGS. 1-3 the lower lift arms 26, 37 have a swiveling ball pivot points 39, 31, 24, 42 attached on at each end, having Category 1 three point hitch size holes 30, 25. The category 1 holes 30, 25 in the swiveling ball joints at the ends of the lift arms, serve to provide attachment points for the two lower lift points of a three-point implement 47 and to keep the installed implement in trail of the tow vehicle. Attached on the top edge of both the left and the right hand lower lift arms, are lift link lower pin mount tabs 22, 29, each of which have holes 36, which provide a mounting point for the lift link mount pins 23, 35, which are best viewed from FIGS. 1 and 3. The use of different holes provides adjustment for the type and category of implement used.

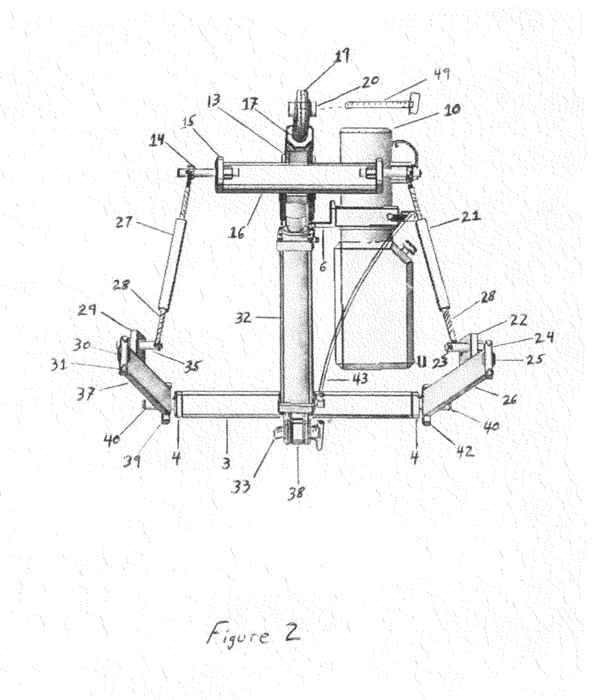

As viewed in FIGS. 1-3, the hydraulic power pack unit 10 mounted to the lift frame on the power pack mount 6, as seen in FIG. 2, serves to provide the hydraulic pressure to operate the separately installed hydraulic cylinder. The vehicles electrical system provides the power supply through a harness 44 to run the electric hydraulic power pack. FIGS. 2 and 3 shows a hydraulic hose 43, which runs between the hydraulic power pack and the hydraulic cylinder and incorporates a quick disconnect 49 at the hydraulic power pack. Control of the T-Point Lift is through a wired harness 44 or wireless remote control (not shown) to the hydraulic power pack, for power up/float down or power up and power down force depending on application of implement. Best viewed in drawing FIGS. 1 and 3, the hydraulic cylinder 32 is installed between two mounting points. One mounting point 38 is located on the lower end of the square frame strut 34 on the lift frame and the other between the mounting plates 11 on the lower edges of the upper lift arm. The hydraulic cylinder 32 is connected to the rest of the assembly with pins 12 and 33 to secure it in place at both ends and allow it to pivot at the top and bottom while in its range of motion.

The foregoing detailed description is given primarily for clearness of understanding and that the present invention is not limited to the description as given above. It is understood that changes, modifications and arrangements of structure, parts and operation can be made by those skilled in the art without departing from the invention listed by the following claim(s)

We claim:

1. A t-point lift, three-point hitch/lift assembly for use on vehicles or equipment, with a 2-inch receiver mounted to their frame, front or rear and said hitch being comprised of:
a receiver bar that provides mounting to a vehicle or equipment by inserting it into said 2 inch receiver mount, and having a horizontal cross member having safety chain tabs. Said cross member having tabs that extend out perpendicular from the frame for mounting of pivot points, which to mount said lower lift arms.
a vertical support tube having a mount attached onto one side for mounting an electric hydraulic power pack assembly and topped off by two plates attached on either side at the top of the vertical support tube, having surfaces that extend out perpendicularly, each with a hole aligned horizontally, which are to facilitate as a pivot point for mounting of the upper lift arm with a removable retaining pin.
a frame strut at the point where the horizontal cross member and the vertical support tube meet, opposite of the receiver mounting bar attached and extending downward below the horizontal cross member, is a hydraulic cylinder mount which serves as a mount for the lower end of the hydraulic cylinder. These parts together form the lift frame of the assembly.

2. The t-point lift, three-point hitch/lift assembly of claim 1, further comprises of:
a upper lift arm consists of a square tube that extends outward from the pivot pin on the lift frame at the top of the vertical support tube. A hydraulic cylinder is mounted to the upper lift arm by mounting plates that extend below the bottom edge of the lift arm tube, and have adjustment holes aligned on each side to adjust mounting of the hydraulic cylinder ram arm with a pin for best possible ground engagement or force possible with the installed implement or device. There are different holes to accommodate different vehicle heights and to provide adjustment to attach different implements.
a horizontal stabilizer bar is mounted on the bottom of the lift arm, square tube. This horizontal stabilizer bar replaceable lift pins to which lift links are installed at each end extending downward to the lower lift arms. At the end of the lift arm square tube is a threaded joint into which fits a threaded adjustable rod that has a rod end serves as the top mount point of three point hitch implements via a category 1 pin hole. These parts together form the Upper Lift arm of the assembly.

3. The t-point lift, three-point hitch/lift assembly of claim 1, further comprises of:
a set of lower lift arm with one end attached to the lift frame and the other open to accept the mount pins of a three point implement. The lower lift arms having a tab with adjustment holes to facilitate mounting of adjustable lift linkage extending up to the mounting pins on the upper lift arm horizontal stabilizer bar.

4. The t-point lift, three-point hitch/lift assembly of claim 1, further comprises of:
a frame mounted electrically powered hydraulic power pack or integrated hydraulic cylinder/power pack, with remote controls required for the operation of the three point hitch to lift the installed three point accessory.
a hydraulic cylinder mounted to the upper lift arm and to the lift frame by mounting plates and hydraulic cylinder mounts. The upper lift arm plates that extend below the bottom edge of the lift arm tube, have adjustment holes aligned on each side to adjust mounting of the hydraulic cylinder ram arm with a removable pin for best possible ground engagement or force possible with the installed implement or device.

5. The t-point lift, three-point hitch/lift, by way of assembly, design and operation, said hitch, maintains the proper parallelogram orientation of the three point implement hitch, using an upper lift arm as the primary lifting device rather than relying on lower lift arms of a traditional three point design to carry the weight of the load installed on the hitch.

6. The t-point lift, three-point hitch/lift, by way of assembly, design and operation, said assembly maintains a variety of adjustments for the fitment of various sizes and design of three point implements without making said assembly a permanent installation to a vehicle or equipment. Said hitch utilizes several different categories of three point implements, not limited to, category 0 and category 1, by way of adjustment and reconfiguration of lift links and upper lift arm mounting points, making said lift more versatile in application and implementation behind or in front of a broader spectrum of vehicles or equipment capable of mounting said device.
